(19) United States
(12) Patent Application Publication
(10) Pub. No.: US 2025/0128560 A1
(43) Pub. Date: Apr. 24, 2025

(54) TRANSPORT SYSTEM WITH SELF-LIFTING WHEEL UNITS FOR FLOOR OBSTACLE TRAVERSAL

(71) Applicant: Intel Corporation, Santa Clara, CA (US)

(72) Inventors: Javier Felix Rendon, Zapopan (MX); Leobardo Campos Macias, Guadalajara (MX); Javier Felip Leon, Hillsboro, OR (US); David Gonzalez Aguirre, Hillsboro, OR (US); Julio Zamora Esquivel, West Sacramento, CA (US)

(21) Appl. No.: 19/000,963

(22) Filed: Dec. 24, 2024

(51) Int. Cl. B60G 17/0165; G01S 17/08; G01S 17/931; G05D 1/65; G05D 109/10

(52) U.S. Cl. CPC B60G 17/0165; G01S 17/08; G01S 17/931; G05D 1/65; B60G 2400/823; B60G 2500/30; G05D 2109/10

(57) ABSTRACT

A transport system, including: a plurality of self-lifting wheel units individually controllable and mounted to a transport platform; one or more sensors mounted to the transport platform and configured to detect a floor obstacle, floor elevation change, or floor surface irregularity; a control system operatively connected to the plurality of self-lifting wheel units and the one or more sensors, wherein the control system is configured to: receive floor obstacle, elevation change, or surface irregularity detection data from the one or more sensors; plan and control the plurality of self-lifting wheel units to selectively lift or lower to maintain stability of the transport platform when traversing the floor obstacle, the floor elevation change, or the floor surface irregularity; and regulate movement of the transport platform to traverse the floor obstacle, the floor elevation change, or the floor surface irregularity based the plan and control.

### BACKGROUND

In many industrial settings, transporting heavy, fragile, and expensive assets is important. Obstacles like cables, hoses, and pipes frequently block paths, particularly in foundries and large clean rooms, where removing them without disrupting operations is difficult.

Existing solutions, including carts and modular robot platforms, cannot handle heavy loads while smoothly crossing such obstacles. Compressible wheels or articulated chassis are unsuitable for substantial weights, and climbing mechanisms create vibrations and abrupt accelerations that risk damaging fragile components such as glass parts or silicon wafers.

Currently, carts require multiple workers and struggle with floor obstacles that cannot be easily moved, such as hoses carrying hazardous gases or power cables. This leads to delays, increased workloads, and higher costs, especially in high-value environments where blocked paths significantly impact productivity.

Despite progress in robotics, no solution reliably supports heavy payloads while navigating over obstacles without imparting vibrations or load shifts. It is difficult to manage strict protocols in dynamic factory floors, and blocked corridors impose hidden but substantial burdens on operations.

The aspects of this disclosure address how to enable human-propelled carts and autonomous mobile robots (AMRs) to seamlessly detect and traverse conduit obstacles using reliable sensor fusion and cost-effective actuation mechanisms, without touching conduits or compromising stability with heavy payloads at human-walking speeds. Additionally, the aspects provide operational stability, ease of use, and auto-calibration capabilities while maintaining the safety and integrity of transported items in shared industrial environments.

### BRIEF DESCRIPTION OF THE FIGURES

FIGS. 1A-1D illustrate various perspectives and a block diagram of a transport system in accordance with aspects of the disclosure.

FIGS. 2A-2B illustrate occupancy maps in accordance with aspects of the disclosure.

FIGS. 3A-3F illustrate a sequential operation of the transport system traversing a floor obstacle in accordance with aspects of the disclosure.

FIGS. 4A-4B illustrate a self-lifting wheel unit in accordance with aspects of the disclosure.

FIG. 5 illustrates a segmentoid kernel in accordance with aspects of the disclosure.

FIGS. 6A-6B illustrate graphs for determining a direct distance to a sphere or line in accordance with aspects of the disclosure.

FIGS. 7A-7C illustrate segmentoid-based artificial neural network parameter shape approximations of free-form conduits in accordance with aspects of the disclosure.

FIGS. 8A-8B illustrate platform-self-lifting wheel unit autocalibration schema in accordance with aspects of the disclosure.

FIG. 9 illustrates a visual simulation of a self-lifting wheel unit as it traverses plurality of floor obstacles in accordance with aspects of the disclosure.

FIG. 10 illustrates a self-lifting wheel unit in accordance with aspects of the disclosure.

FIG. 11 illustrates a level orchestrator in accordance with aspects of the disclosure.

FIGS. 12A-12C illustrate a wheel position sequence of a self-lifting wheel unit in accordance with aspects of the disclosure.

FIG. 13 illustrates ground forces reaction of a self-lifting wheel unit in accordance with aspects of the disclosure.

FIG. 14 illustrates liquid avoidance by a self-lifting wheel unit in accordance with aspects of the disclosure.

FIGS. 15A-15C illustrates surface deviation adaptation via a level compensator of a self-lifting wheel unit in accordance with aspects of the disclosure.

### DETAILED DESCRIPTION

The present disclosure is directed to a transport system that is a modular hazard and stability solution designed for enhanced floor obstacle traversal. This transport system integrates four-dimensional range sensing, advanced motion planning, wheel-lifting actuation, and smooth control mechanisms. Its primary objective is to ensure prompt and precise wheel-lifting actuation—accounting for phase, force, and velocity—while dynamically adapting to the shape and characteristics of detected obstacles. This adaptation is achieved through the fusion of two orthogonal range sensors, enabling platforms (or carts) and Automated Mobile Robots (AMRs), whether human-propelled or autonomously-propelled, to stably and continuously traverse floor obstacles such as hoses, wires, and pipes. By eliminating stop-and-go interruptions or the need for ramps, the transport system enhances productivity in cost-intensive, rapid-response operations without compromising safety.

During tool installations or routine maintenance, carts frequently cross conduits such as hoses carrying toxic gases, corrosive liquids, power lines, and delicate fiber optics. Traditional solutions like ramps are unsuitable due to induced cart vibrations and inclinations that can compromise the transport of sensitive tools and supplies. Without the disclosed transport system, such operations are delayed by time-intensive obstacle removal or navigating narrow, lengthy corridors across both fabrication plant and sub-fabrication levels, resulting in inefficiencies and increased costs.

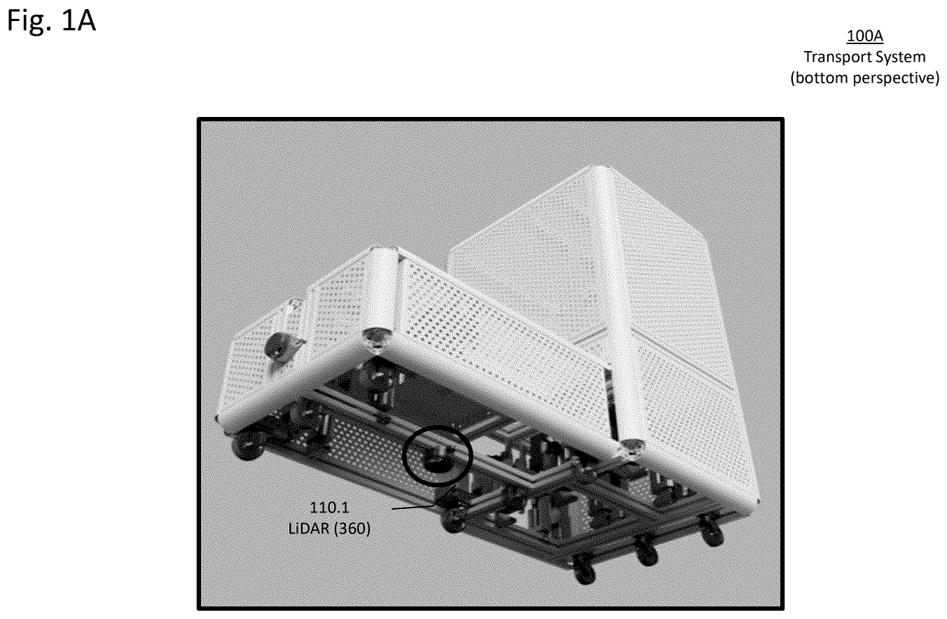

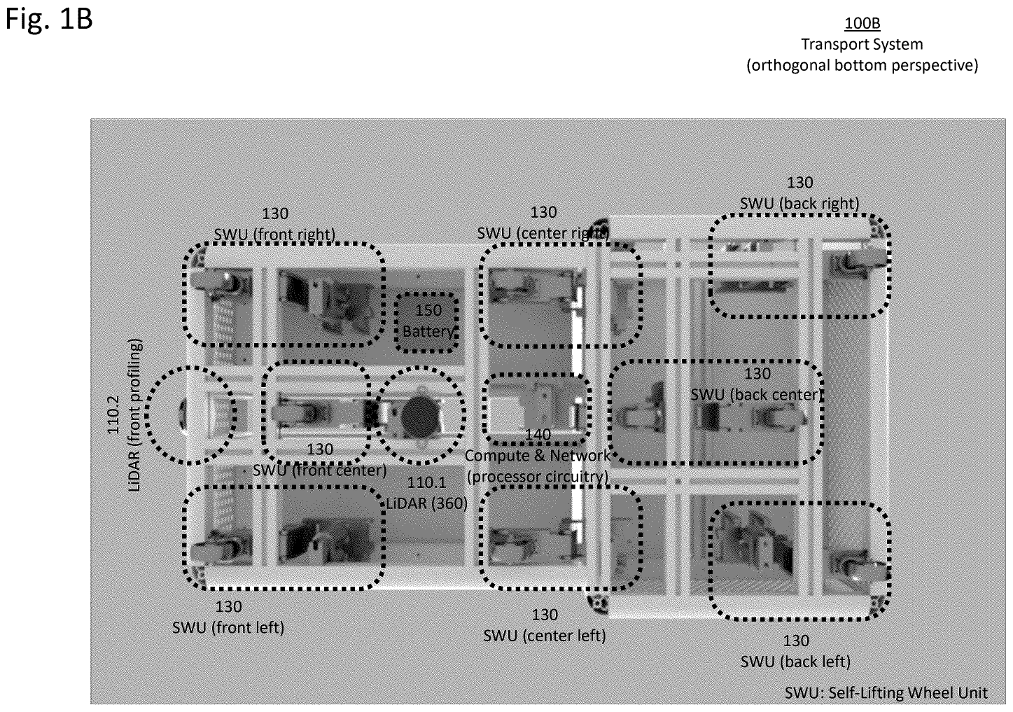

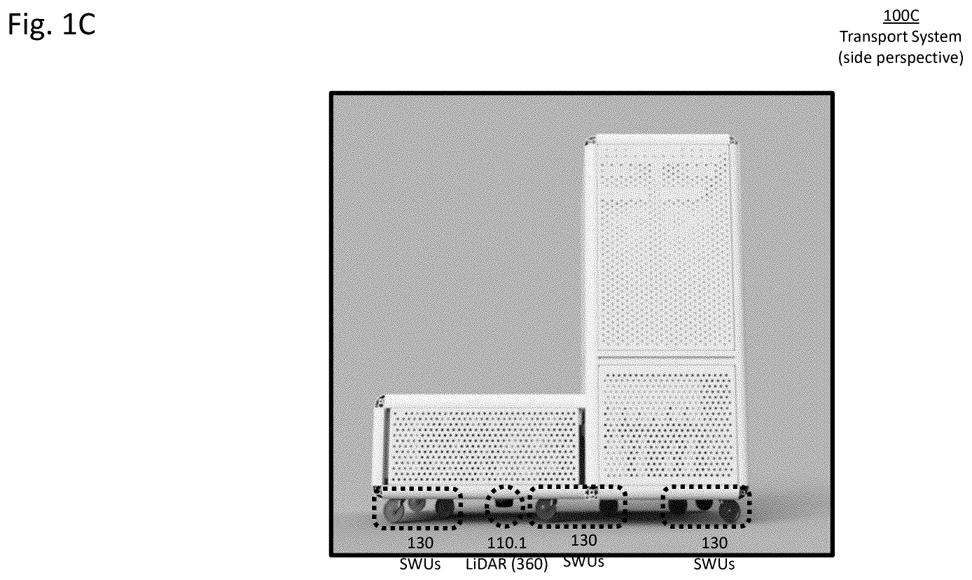

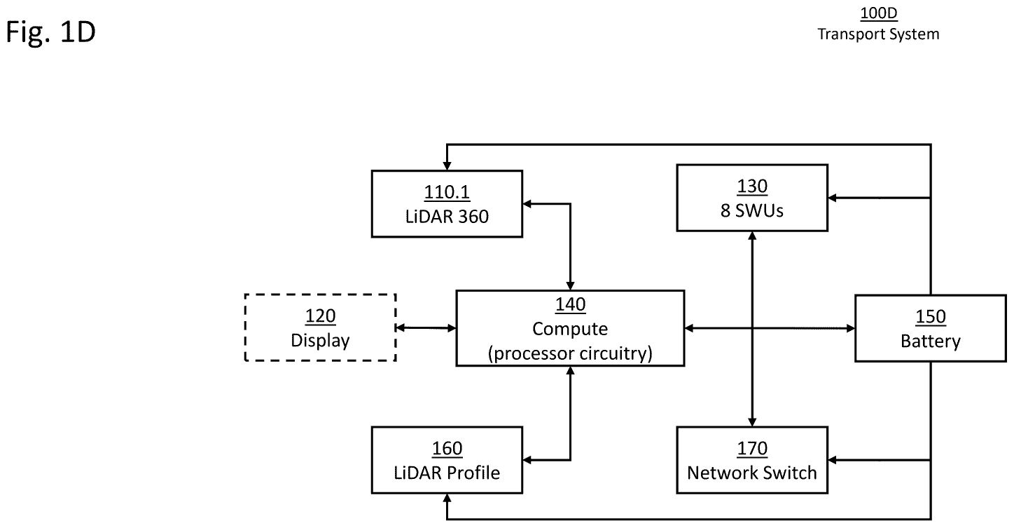

FIGS. 1A-1D illustrate various perspectives and a block diagram of a transport system 100 in accordance with aspects of the disclosure. Specifically, FIG. 1A illustrates a bottom perspective of the transport system 100A, FIG. 1B illustrates an orthogonal bottom perspective of the transport system 100B, FIG. 1C illustrates a side perspective of the transport system 100C, and FIG. 1D illustrates a block diagram of the transport system 100D.

The transport system 100 overcomes the challenges of navigating floor obstacles like cables, hoses, and pipes in industrial environments, for example. It implements concurrent operation of its perception, planning, and control mechanisms. The centipede-like mechanism for lifting and lowering wheel units adapts to a perceptual map generated by two range sensors (LIDAR and/or RGB/D) 110. This allows the motion planning and control system to adjust to the specific distribution of floor obstacles or inform a user via an optional screen display 120 if a dependable sequence to avoid the path is not available. The transport system 100 has eight self-lifting wheel units (SWU) 130, two orthogonal range sensors (LiDAR) 110, compute and networking units (processor circuitry) 140, and a battery with power DC-DC conversion unit 150. There is also a memory 160 for storing a LiDAR profile and a network switch 170 that communicates with sensors or devices that are not directly connected to the onboard computer via USB or the like. Of course the transport system 100 is not limited to this particular design or number of range sensors 110 or SWUs 130, and modifications may be made without departing from the scope of the disclosed aspects.

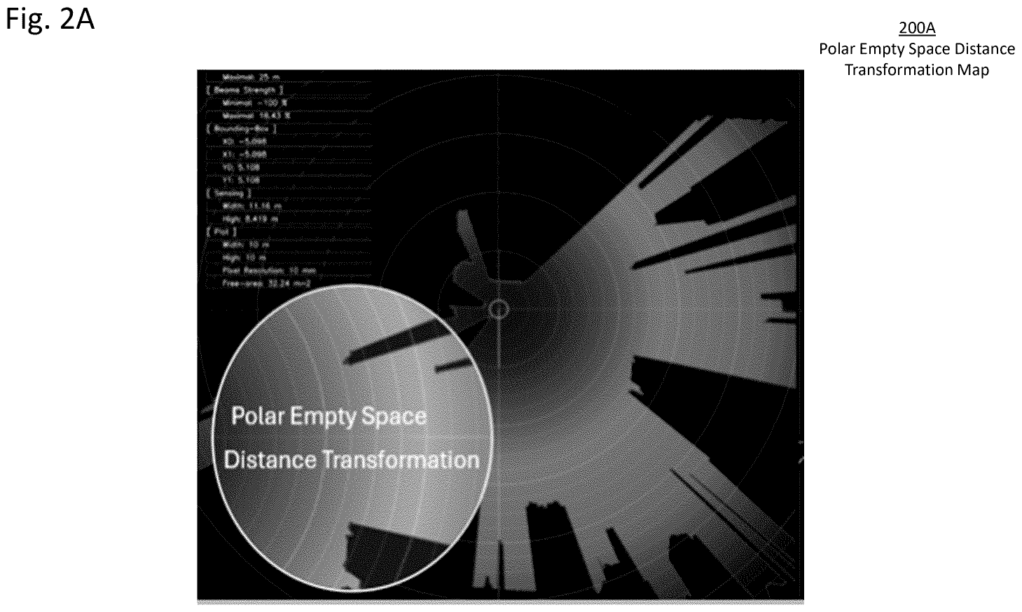

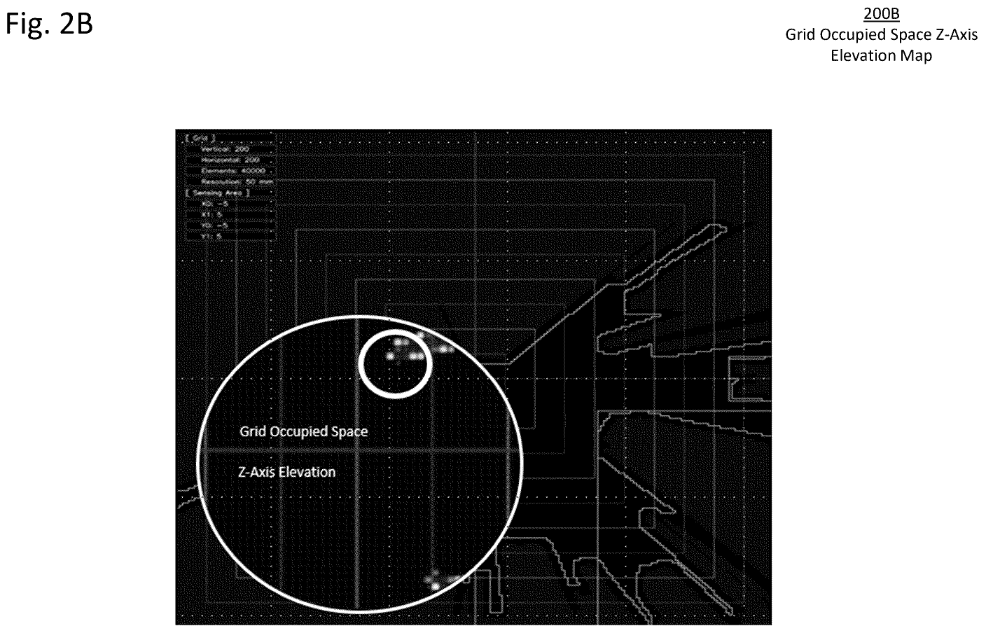

FIGS. 2A-2B illustrate occupancy scans 200 in accordance with aspects of the disclosure.

FIG. 2A illustrates a polar empty space distance transformation map 200A. The map 200A represents the continuous spatial awareness signals from the 360-degree range sensing system, showing the polar coordinate representation of empty space around the cart. This transformation enables real-time detection and mapping of potential obstacles, allowing the transport system 100 to plan wheel lifting sequences while maintaining stable navigation.

FIG. 2B illustrates a grid occupied space Z-axis elevation map 200B. The map 200B displays a time-varying discrete occupancy and elevation maps (three dimensions plus time) generated by the transport system 100's perception components. This grid-based representation combines data from the two orthogonal range sensors 110 to create three-dimensional mapping for motion planning and control in real time. The Z-axis elevation data is useful for identifying the height and distribution of floor obstacles that require wheel lifting actions.

The maps 200 can work together as part of the transport system 100's four-dimensional spatial representation capabilities, which in conjunction with an inertial measurement unit (IMU) and wheel odometry, allow the motion planner to create and determine feasible sequences to traverse floor obstacles.

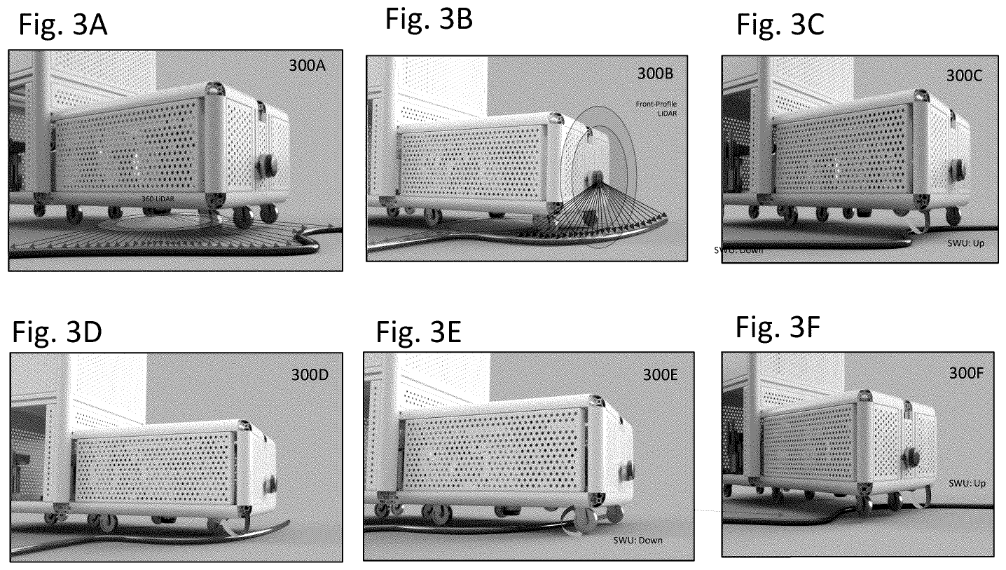

FIGS. 3A-3F illustrate a sequential operation 300 of the transport system 100 traversing a floor obstacle in accordance with aspects of the disclosure.

FIG. 3A illustrates an initial detection state 300A, which shows the transport system 100 approaching the floor obstacle (conduit) while the transport system's perception components (LiDAR and range sensors) 110 detect and assess the conduit.

FIG. 3B illustrates an obstacle assessment phase 300B. The front-profiling LIDAR 110.2 and 360-degree sensors 110.1 create a detailed perceptual map of the obstacle, allowing the motion planning system to determine the appropriate wheel lifting sequence.

FIG. 3C illustrates an initial wheel lifting phase 300C. The transport system 100 begins executing the wheel lifting sequence, with the first SWU 130 elevating to clear the floor obstacle while maintaining platform stability through the other ground contact points.

FIG. 3D illustrates a traversal phase 300D. The transport system 100 continues forward movement as additional wheels sequentially lift and lower, preferably maintaining at least three or four contact wheels during traversal to ensure stability and proper load distribution.

FIG. 3E illustrates a wheel lowering sequence 300E with controlled lowering of the lifted wheel as it clears the floor obstacle, with the transport system 100 actively monitoring platform orientation and stability through IMU sensors and zero-moment point (ZMP) calculations.

FIG. 3F illustrates a completion state 300F where the wheel returns to ground contact, completing the floor obstacle traversal while maintaining the platform's stability and orientation throughout the sequence.

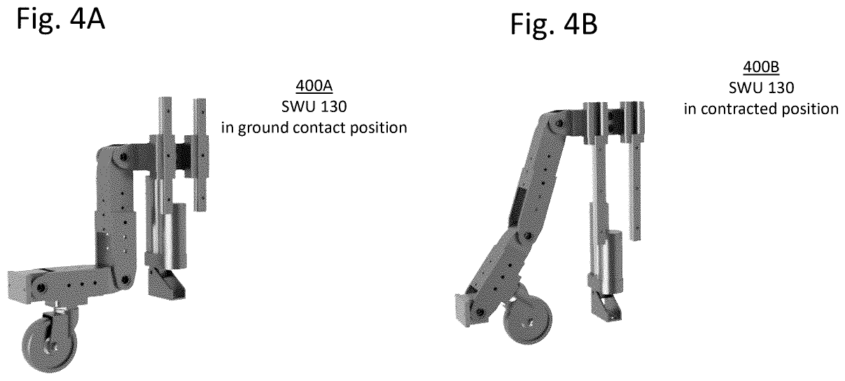

FIGS. 4A-4B illustrate a self-lifting wheel unit (SWU) 130 in accordance with aspects of the disclosure.

The SWU 130 is mounted on an articulated, sub-actuated limb that can contract and expand, adapting to varying payload and floor obstacle conditions. The limb is engineered to support heavy payloads while maintaining structural integrity and smooth operation. Additionally, the transport system 100 includes an auto-calibration feature described below, ensuring that the SWU 130 maintains precise alignment and functionality without requiring manual intervention.

FIG. 4A illustrates a SWU configuration when its wheel is touching the floor. The SWU 130 is shown in its ground contact position, where the articulated limb is fully extended to maintain wheel contact with the floor. This configuration includes the chassis mounting with damping capabilities and the instrumented wheel connected through the articulated mount, enabling stable load-bearing operation during transport.

FIG. 4B illustrates a SWU configuration when retracted. This counterpart configuration shows the SWU 130 in its maximum retracted state, where the articulated limb contracts upward to lift the wheel clear of floor obstacles. The mechanism utilizes an electromechanically actuated piston that applies forces of 1.5-3 Kilo Newton, for example, capable of lifting (in combination with four SWUs) to two to four times the maximum payload of 300 kg, for example, for a large safety margin.

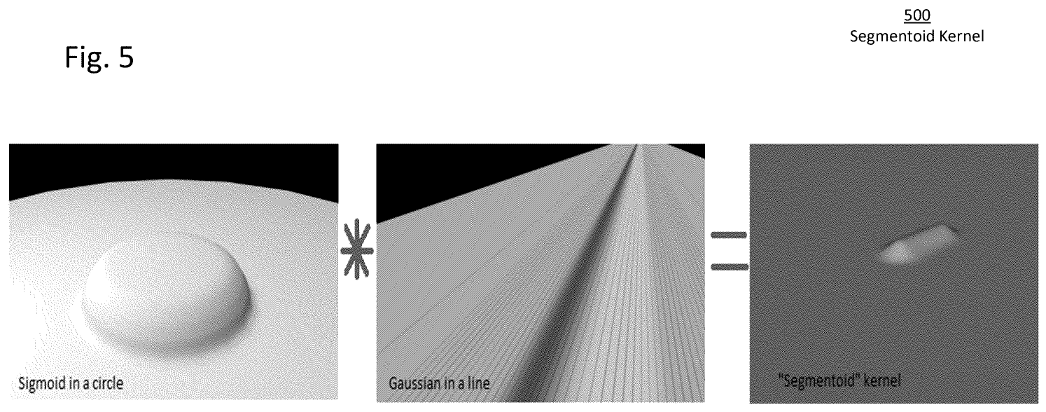

FIG. 5 illustrates a segmentoid kernel 500 in accordance with aspects of the disclosure. A “segmentoid” kernel” is a new concept with this disclosure. It a product of a sigmoid and a gaussian kernel to generate a segmentoid kernel.

The disclosed transport system 100 incorporates artificial intelligence four-dimensional range sensing to provide reliable situational awareness and sharp control cues for floor obstacle navigation and traversal. This transport system 100 combines two orthogonal range sensors 110 with an artificial neural network (ANN) to deliver comprehensive 360-degree horizontal views at the bottom of the transport system 100 and a forward-facing view. These combined views enable precise assertion of blocked pathways through cone detection, markings, or other visual indicators, as well as the identification of the shape and spatial distribution of floor obstacles. The transport system 100 is designed to exploit the generalization capabilities of the ANN while reducing resource consumption for power efficiency.

The ANN for conduit perception system leverages a fully connected neural network (NN) architecture with two layers. However, each neuron operates as a segmentoid kernel, enhancing its performance and adaptability for obstacle detection and classification.

The segmentoid kernel is defined as the product of two widely recognized kernels: the Gaussian kernel u=e^{-r}^{²}, commonly used in Radial Basis Function (RBF) neural networks for smooth function approximation and generalization, and the sigmoid kernel v=1/(1+e^{-ρ}), a standard activation function used in Multilayer Perceptrons (MLP) to model non-linear relationships.

The resulting segmentoid function, illustrated in FIG. 5, combines the strengths of these two kernels, enabling precise obstacle perception with reduced computational overhead. The segmentoid function is defined as the product of both aforementioned kernels:

$$a = uv = \frac{{e}^{- {r}^{2}}}{1 - {e}^{- ρ}} , \qquad ( Equation 1 )$$

where r is the distance to the line generated by P₁ and P₂, and ρ is the distance to the center of the circle (P₁+P₂)/2 and diameter ∥P₁−P₂∥.

This segmentoid-based perception system ensures accurate detection of conduits, pathways, and environmental obstacles, making it well-suited for real-time applications where efficiency and reliability are desired.

The output layer of the disclosed system is a simple perceptron, where the input layer represents a collection of segments used to interpolate the cable. Training of the perceptron is performed using the gradient descent algorithm, with the sigmoid activation function defined as:

$$f = 1 / ( 1 + {e}^{- s} ) , \qquad ( Equation 2 )$$

where s=Σwa is the linear combination of inputs, that is, the first layer's outputs.

To use the gradient descendant algorithm, the error function is defined as:

$$E = \frac{1}{2} {( d - f )}^{2} , \qquad ( Equation 3 )$$

where d is the desired output for a given input (x, y). The training aims to reduce this error by adjusting the weights of the perceptron. A LiDAR occupancy image used for input is binarized to detect edges, assigning a value of 1 to border pixels and 0 to the background.

The training rule for the i-th weight wᵢ is derived using the error derivative (using the gradient descendant method):

$$\frac{\partial E}{\partial {w}_{i}} = ( d - f ) ( 1 - f ) {fx}_{i} . \qquad ( Equation 4 )$$

Following the same procedure, it is possible to compute the training rules for the components of a pair of points that reduces the error and the adjustment of each line segment to the detected edges in the image. To find the training rules using the gradient descendant method, the partial derivatives of the kernel are

$$\frac{\partial a ( x , y )}{\partial {x}_{0}} ,$$

with partial derivatives written as:

$$\frac{\partial a}{\partial {x}_{0}} = uv ( 1 - v ) \frac{\partial ρ}{\partial {x}_{0}} - 2 ruv \frac{\partial r}{\partial {x}_{0}} = a ( ( 1 - v ) \frac{\partial ρ}{\partial {x}_{0}} - 2 r \frac{\partial r}{\partial {x}_{0}} ) . \qquad ( Equation 5 )$$

The derivative of the activation function's argument ρ, representing the distance from a point to the surface of the sphere generated by points P0(x0, y0) and P1(x1, y1), is calculated.

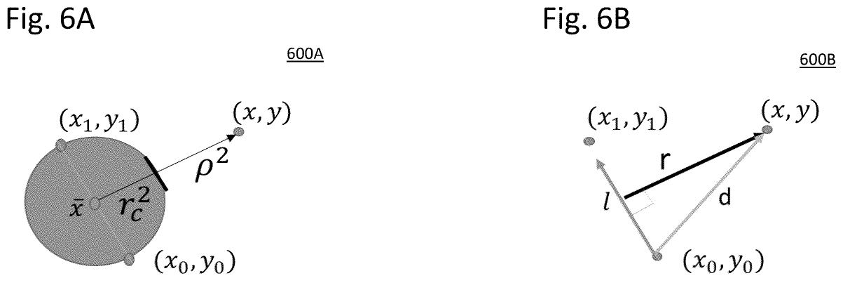

FIGS. 6A-6B illustrate graphs 600 for determining a direct distance to a sphere 600A or line 600B in accordance with aspects of the disclosure. Specifically, FIG. 6A illustrates a graph 600A for determining a direct distance to the sphere generated by p1 and p2, and FIG. 6B illustrates a graph 600B for determining a direct distance to the line generated by p1 and p2.

The squares of magnitude to reduce computational complexity is represented as:

$${ρ}^{2} = {( x - \overline{x} )}^{2} + {( y - \overline{y} )}^{2} - {r}_{c}^{2} , \qquad ( Equation 6 )$$

computing the partial derivative in terms of:

$${x}_{0} , \frac{\partial {ρ}^{2}}{\partial {x}_{0}} = \frac{\partial }{\partial {x}_{0}} {( x - \overline{x} )}^{2} + 0 - \frac{\partial {r}_{c}^{2}}{\partial {x}_{0}} , \qquad ( Equation 7 )$$

hence

$$\frac{\partial {ρ}^{2}}{\partial {x}_{0}} = - 2 ( x - \overline{x} ) \frac{\partial \overline{x}}{\partial {x}_{0}} - \frac{1}{4} \frac{\partial }{\partial x} ( {( {x}_{1} - {x}_{0} )}^{2} ) , \qquad ( Equation 8 )$$

replacing the value of x̅ which represents the center of the sphere:

$$\frac{\partial {ρ}^{2}}{\partial {x}_{0}} = - 2 ( x - \frac{{x}_{1} + {x}_{0}}{2} ) \frac{\partial ( {x}_{1} + {x}_{0} )}{2 \partial {x}_{0}} - \frac{1}{2} ( {x}_{1} - {x}_{0} ) \frac{\partial }{\partial {x}_{0}} ( {x}_{1} - {x}_{0} ) , \qquad ( Equation 9 )$$

and simplifying

$$\frac{\partial {ρ}^{2}}{\partial {x}_{0}} = - x + \frac{{x}_{1} + {x}_{0}}{2} + \frac{1}{2} ( {x}_{1} - {x}_{0} ) = {x}_{1} - x . \qquad ( Equation 10 )$$

To compute ∂r/∂x₀ where r represents the distance to the line created by the points p0 (x0, y0) and p1 (x1,y1). The distance to the point (x, y) to the line can be computed using the cross product of the vectors r=d×\hat{l}, and

$$\frac{\partial }{\partial {x}_{0}} r = \frac{\partial d \times 1}{\partial {x}_{0}} .$$

Replacing d and l with the vectors and computing the cross product simplifies to:

$$\frac{\partial }{\partial {x}_{0}} r = - ( {y}_{1} - {y}_{0} ) + ( y - {y}_{0} ) = y - {y}_{1} . \qquad ( Equation 11 )$$

Following the same procedure, the partial derivative of kernel a respect to x1,y0, and y1 provides the rules for training:

$${x}_{0}^{′} = {x}_{0} - δ ( ( 1 - v ) ( {x}_{1} - x ) - 2 r ( {y}_{1} - y ) ) \qquad ( Equations 12 )$$

$${x}_{1}^{′} = {x}_{1} - δ ( ( 1 - v ) ( {x}_{0} - x ) - 2 r ( y - {y}_{0} ) )$$

$${y}_{0}^{′} = {y}_{0} - δ ( ( 1 - v ) ( {y}_{1} - y ) - 2 r ( x - {x}_{1} ) )$$

$${y}_{1}^{′} = {y}_{1} - δ ( ( 1 - v ) ( {y}_{0} - y ) - 2 r ( {x}_{0} - x ) )$$

where δ is given by,

$$δ = η ( d - f ) ( 1 - f ) {fw}_{i} {a}_{i} , \qquad ( Equation 13 )$$

and η is a scalar that is the learning rate.

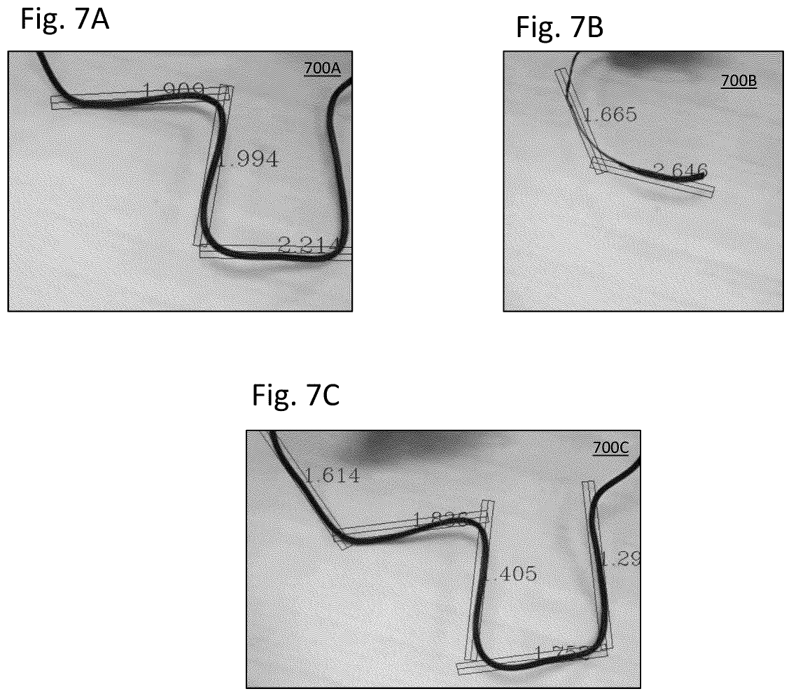

The tracking of a flexible cable is shown in FIGS. 7A-7C. Here, line segments divide the body of the cable in segments and track them automatically, which creates a navigation plan to cross the segments by lifting a wheel at a time.

FIGS. 7A-7C illustrate segmentoid-based artificial neural network (ANN) parameter shape approximations 700 of free-form conduits in accordance with aspects of the disclosure. This approach highlights the model's generalization capabilities, allowing it to adapt to varying conduit shapes effectively.

The inference process employs a variable number of neurons, dynamically adjusting to identify line segments based on their stability and representativeness. Minor variations at inflection regions, typically within a range of 1-2 cm, are automatically compensated by the transport system 100's safety margin during motion planning, ensuring consistent and reliable operation.

An advantage of this model lies in its invariance to signal content and its tolerance to noise and outliers, attributes derived from the innovative segmentoid kernel shown in FIG. 5. These features make the model particularly suitable for environments with unpredictable or noisy inputs, enabling accurate and efficient parametric representation of obstacles for navigation and control.

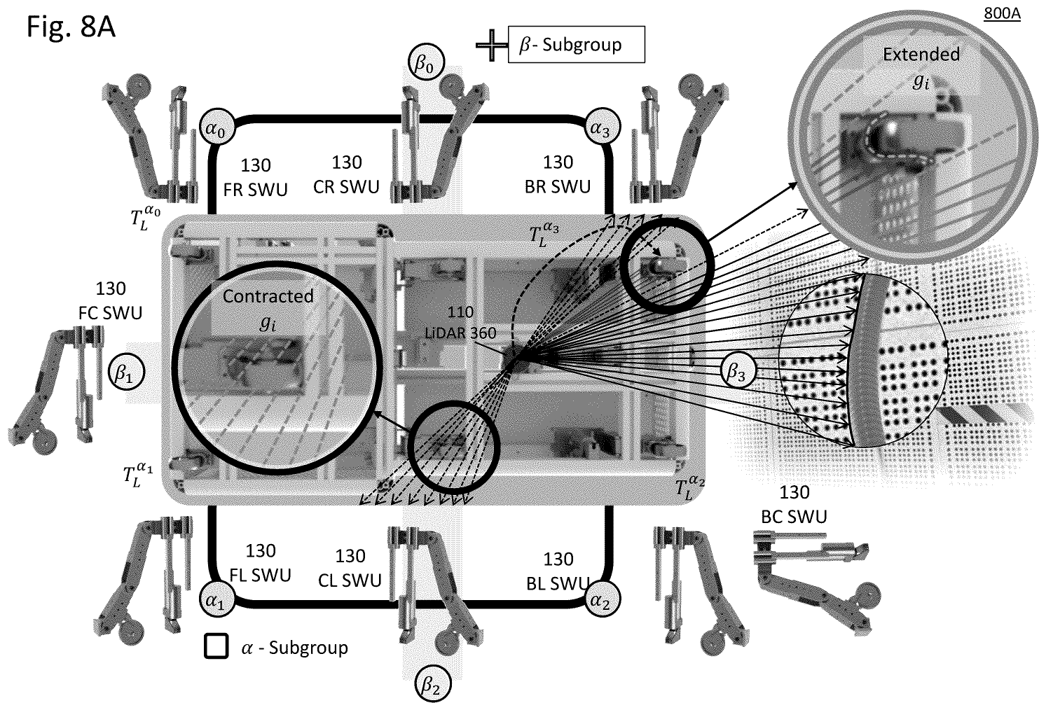

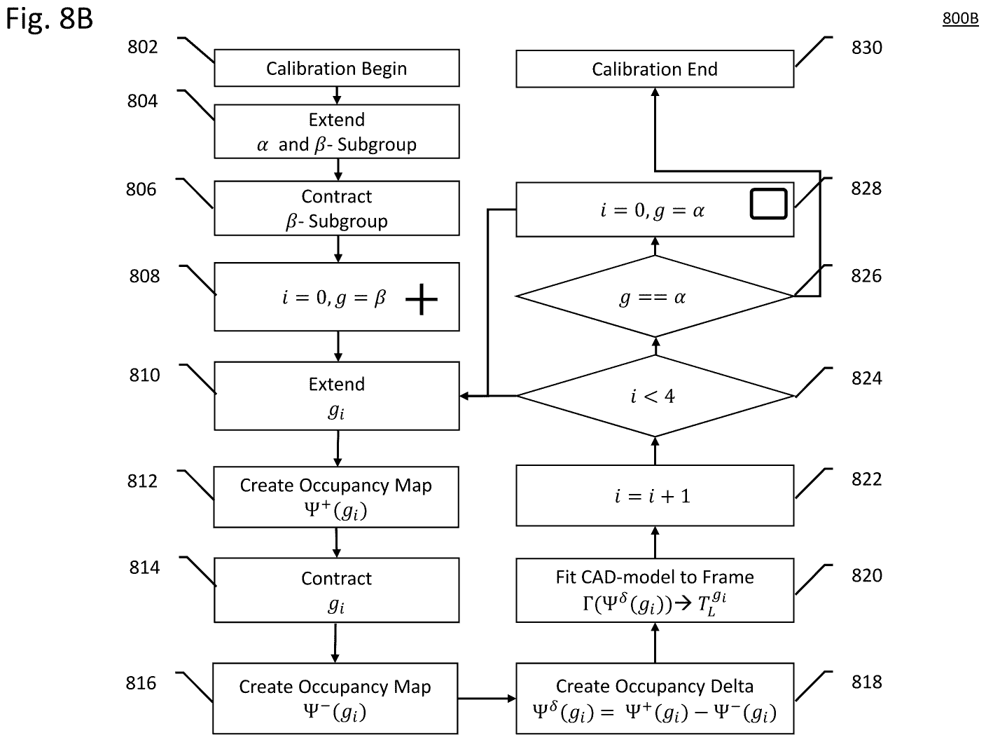

FIGS. 8A-8B illustrate platform-self-lifting wheel unit autocalibration process 800 in accordance with aspects of the disclosure.

This motion planning and control algorithm relies on geometric relationships between the six-dimensional poses of the SWUs 130 and LiDAR sensors 110, which are specified using the Robot Operating System (ROS) Universal Robot Description Format (URDF). The URDF defines the actuator and sensor types and their location on the platform (cart), enabling transformation of sensor scans into unified coordinates.

The automatic calibration process 800 is illustrated in FIG. 8B and includes alpha (α) and beta (β) subgroups of self-lifting wheel units (SWUs) 130 that enable stable sequential extension and contraction to determine wheel positions and orientations relative to the 360-degree sensors (LiDARs 110). The protocol operates by alternating occupancy scans Ψ(see FIG. 2B) to detect the presence Ψ⁺(gᵢ) and absence Ψ⁻(gᵢ) of occupancy quads at high resolution. Using this differential occupancy information Ψ^{δ}(gᵢ), a Computer-Aided Design (CAD) model fitting Γ optimizes the pose T_{L}^{g}^{ᵢ} and determines the composed transformation Γ(Ψ^{δ}(gᵢ))→T_{L}^{g}^{ᵢ} for each SWU 130. The calibration maintains cart stability by utilizing two subgroups (α and β) of SWUs 130 that operate sequentially.

The autocalibration process 800B initiates with “Calibration Begin” (Step 802), followed by simultaneously extending both the alpha (α) and beta (β) subgroups of the SWUs 130 (Step 804). Subsequently, the beta subgroup is contracted while maintaining the alpha subgroup in its extended position (step 806).

The autocalibration process 800B then enters its main iterative phase by initializing counters (i=0) and setting the initial group selection to beta (g=β) (Step 808). For each iteration, the following sequence occurs.

First, the current SWU 130 (gᵢ) is extended (Step 810), and an occupancy map Ψ⁺(gᵢ) is created to capture the spatial configuration in the extended state (Step 812). The SWU 130 is then contracted (Step 814), and a second occupancy map Ψ⁻(gᵢ) is generated for the contracted position (Step 816). The notation “+” means that the SWU 130 is extended, as shown in the upper right-hand circles, and the notation “−” means that the SWU 130 is contracted, as shown in the left-hand, darker circles.

An occupancy delta Ψ^{δ}(gᵢ) is calculated by subtracting the contracted occupancy map from the extended occupancy map (Ψ^{δ}(gᵢ)=Ψ⁺(gᵢ)−Ψ⁻(gᵢ)) (Step 818). This delta information is used to fit a CAD model to the frame, represented by the transformation Γ(Ψ^{δ}(gᵢ))→T_{L}^{g}^{ᵢ} (Step 820).

After each iteration, the counter i is incremented by 1 (Step 822). The process continues while i<4 (Step 824), creating a loop that processes multiple SWUs 130 within each subgroup. When g equals a (Step 826), the process 800B transitions to calibrating the alpha subgroup SWUs 130 using the identical sequence of operations.

The calibration process concludes (“Calibration End” Step 830) after completing the iterations for both subgroups, having determined the precise positions and orientations of the SWUs 130.

The calibration process is conducted during the assembly of the transport system 100 or following any maintenance activity performed thereon. The SWUs 130 are precisely aligned relative to the LiDARs 110 to ensure good performance. If the event of mechanical deviations caused by wear and tear of the wheels, the transport system 100 remains operational and maintains its performance standards.

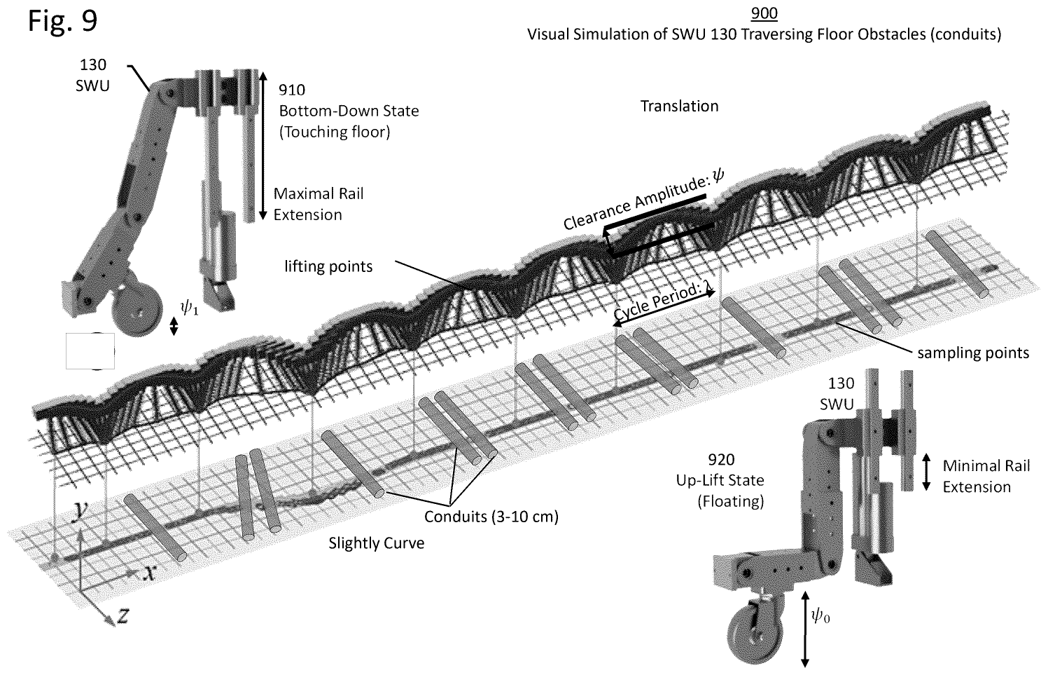

FIG. 9 illustrates a simulation 900 of a self-lifting wheel unit 130 as it traverses plurality of floor obstacles in accordance with aspects of the disclosure.

The figure depicts two states of the SWU 130: a bottom-down state 910, in which the wheel contacts the floor with maximal rail extension, and an up-lift state 920, in which the wheel is floating with reduced rail extension. The SWU 130's movement is characterized by a cycle period that represents the timing of the lifting and lowering actions.

The central portion of the figure shows a simulation of the SWU 130 traversing multiple conduits ranging from 3-10 cm in height along a slightly curved path. The clearance amplitude ψ represents the maximum vertical distance the SWU 130 can achieve to clear obstacles. The simulation 900 illustrates the translation motion as the SWU 130 navigates over the conduits through coordinated extension and retraction of the rails.

The cycle period λ of the lifting action is a performance metric that indicates the transport system 100's responsiveness, enabling coordination with either human-controlled movement or automated motion planning systems. The simulation 900 demonstrates how the SWU 130 maintains consistent clearance amplitude while adapting to multiple obstacles in sequence.

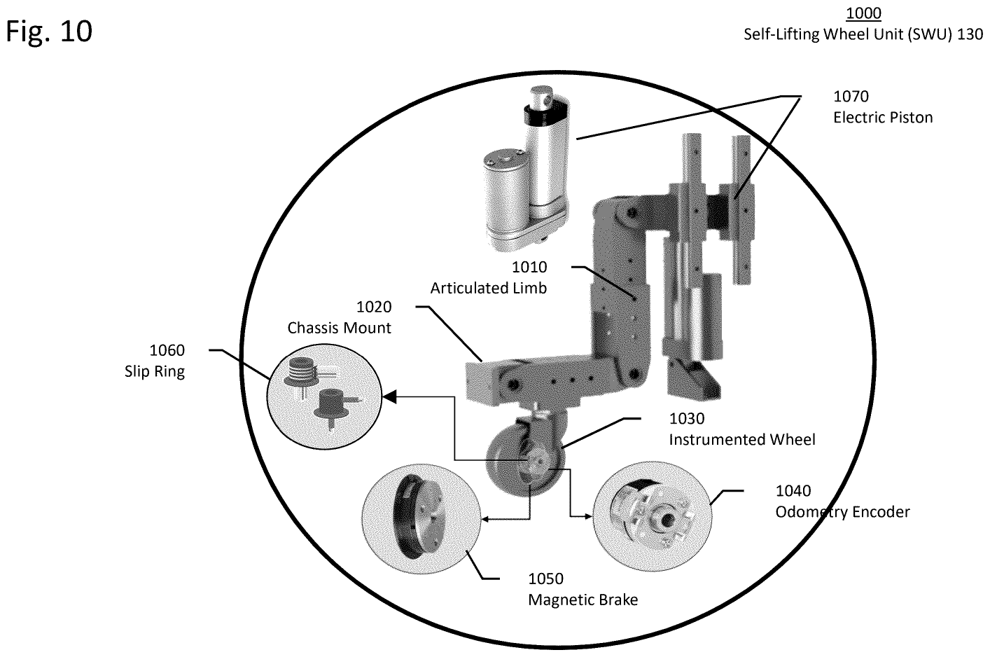

FIG. 10 illustrates a self-lifting wheel unit (SWU, 130) designated as 1000 in accordance with aspects of the disclosure.

The SWU 1000 comprises multiple integrated components arranged on an articulated limb 1010 serving as a motion chassis for mounting and wiring elements. A chassis mount 1020 equipped with damping capabilities.

An instrumented wheel 1030 supports various configurable mounting options. An odometry (rotational) encoder 1040 provides continuous wheel rotation measurement. A magnetic brake 1050 delivers velocity control and collisions prevention. A slip ring 1060 provides uninterrupted power and signal transmission. An electric piston 1070 generates substantial lifting force (e.g., ranging from 1.5 to 3 kilonewtons).

The SWU 1000 implements a force control algorithm based on real-time current estimation, allowing it to dynamically adapt to floor obstacles and ensure smooth, stable motion. This reduces vibrations and mitigates unstable movements during traversal.

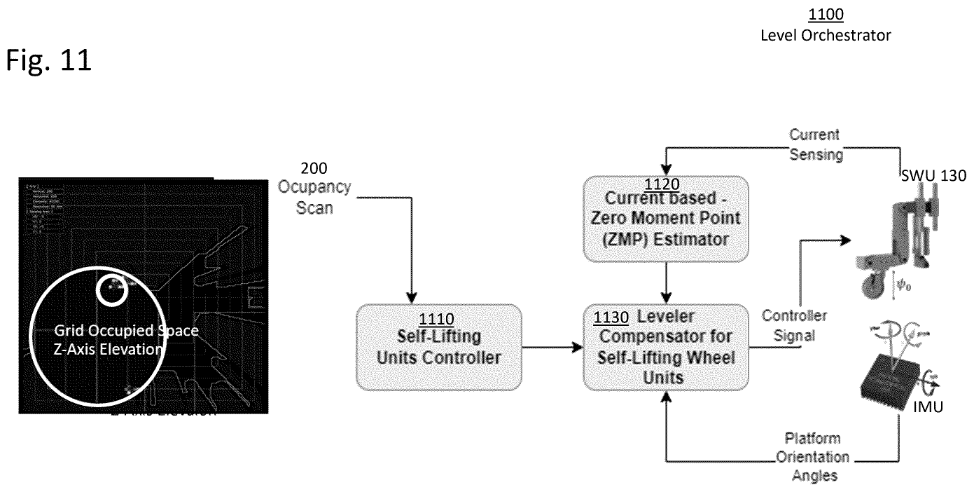

FIG. 11 illustrates a leveler orchestrator 1100 in accordance with aspects of the disclosure.

The SWU 1000's operation is coordinated through a leveler orchestrator 1100 that processes occupancy scan data, estimates the zero-moment point (ZMP) based on current sensing, and provides compensated control signals to maintain platform stability and orientation during obstacle traversal.

The occupancy scan data feeds into a self-lifting wheel units controller 1110, which processes the environmental information to generate initial control commands. These commands determine which wheel units should be elevated and alter the wheel distances ψᵢ with respect to the ground to navigate around detected obstacles. The commands are then passed to a leveler compensator 1130 for the self-lifting wheel units 130.

The leveler orchestrator 1100 incorporates a current-based zero-moment point (ZMP) estimator 1120 that receives current sensing data from the SWUs 130. This ZMP estimator 1120 works in conjunction with the leveler compensator 1130 to maintain platform stability. The ZMP estimator 1120 calculates the ZMP based on the current control signals for each SWU 130 to ensure it stays within the convex hull formed by the wheel contact points on the ground, which is important for preserving platform stability. The leveler compensator 1130 receives both the ZMP estimates and platform orientation angles as inputs to generate appropriate controller signals for the SWUs 130.

The leveler compensator 1130 transmits the controller signals to the SWUs 130 to adjust their positions and maintain stable platform orientation during operation. This closed-loop control system continuously monitors and adjusts the platform's position through current sensing and real-time orientation feedback to prevent the platform from tipping and ensure stable operation.

The self-lifting wheel units controller 1110 controls individual SWUs 130 as separate dynamic entities that respond to control signals as defined in: u=f(e). The controller 1110 implements an error-based control scheme where the error term expressed as e=ψ−ψ_{ground}, which represented the difference between a desired wheel-to-ground distance and the actual distance, with the goal of maintaining ground contact for wheels while enabling obstacle avoidance. The controller 1110 addresses the collective behavior of the SWUs 130 to guarantee overall platform stability. The function f(⋅) could be various control strategies, such as a PID (Proportional-Integral-Derivative) controller or a sliding mode controller, though it is not limited to these types. The controller 1110 then utilizes feedback from the occupancy scan 200 to generate virtual forces in response to detected obstacles. These virtual forces influence the control signals that adjust the wheel-to-ground distances. The refined controller signal combines both the base error correction and the obstacle-induced virtual forces and is represented by:

$${u}_{e} = f ( e ) + γτ ( d ) . \qquad ( Equation 14 )$$

In this control input, γ is a weighting parameter that determines the magnitude of the virtual force's influence on the control signal. A distance-dependent function τ modulates this influence based on the relative positioning between detected obstacles and the wheel location d. As this distance diminishes, the function τ increasingly affects the control signal, prompting the wheel to elevate.

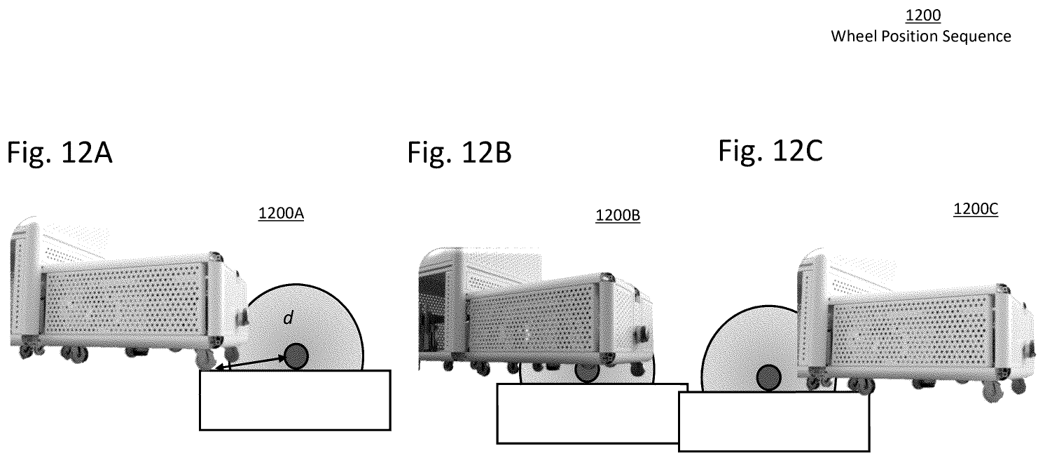

FIGS. 12A-12C illustrate a temporal wheel position sequence 1200 of a self-lifting wheel unit 130 alongside an obstacle on the ground in accordance with aspects of the disclosure.

FIG. 12A depicts the initial state 1200A as the transport system 100 approaches an obstacle, where the relative distance d between the wheel and obstacle is sufficiently large that the wheel maintains ground contact without activation of the lifting mechanism.

FIG. 12B shows an intermediate state 1200B where the decreased relative distance between the wheel and obstacle triggers the control system to initiate wheel elevation, lifting the SWU 130 to navigate over the detected obstacle.

FIG. 12C illustrates the final state 1200C where the SWU 130 returns to its operating position with restored ground contact after clearing the obstacle. The transport system 100 implements distance-dependent functions to ensure smooth transitions between the elevated and grounded wheel positions throughout this sequence.

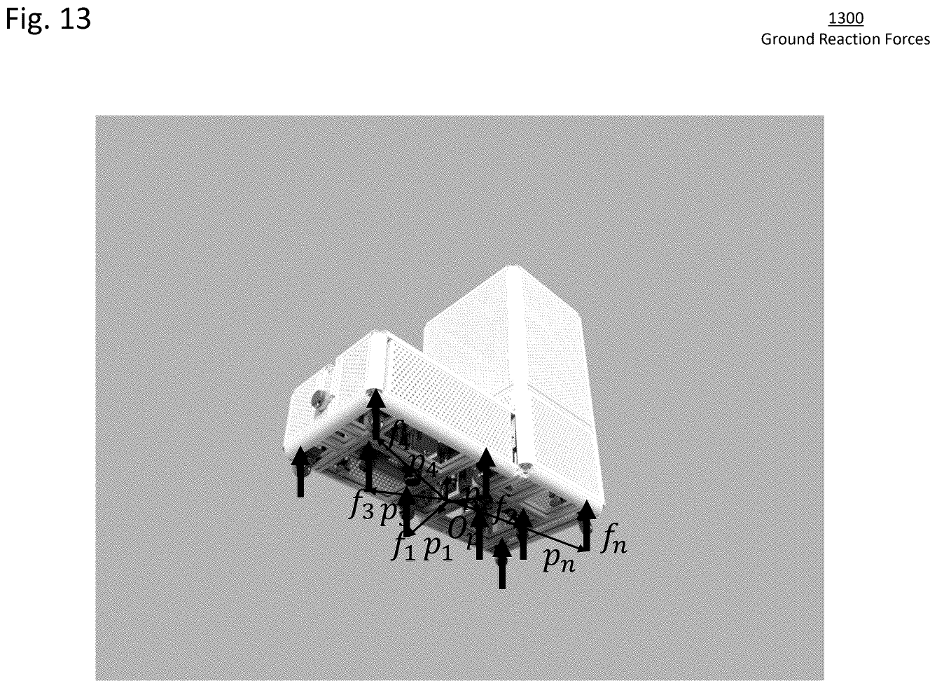

FIG. 13 illustrates ground reaction forces 1300 of a self-lifting wheel unit in accordance with aspects of the disclosure.

The figure depicts a platform with multiple contact points pᵢ where ground reaction forces fᵢ are applied. These forces are modeled as three-dimensional vectors fᵢ=[fᵢₓ, f_{iy}, f_{iz}]^{T} acting upon discretized points distributed across the platform's base.

The distributed N force vectors are replaced by a force and moment vector acting at point p according to the equations:

$$f = {\sum }_{i = 1}^{N} {f}_{i} , τ ( p ) = {\sum }_{i = 1}^{N} ( {p}_{i} - p ) \times {f}_{i} , \qquad ( Equation 15 )$$

where i ranges from 1 to N.

The zero-moment point (ZMP) position is calculated by equating the first and second elements, yielding:

$$p = \frac{{\sum }_{i = 1}^{N} {p}_{i} {f}_{iz}}{{\sum }_{i = 1}^{N} {f}_{i z}} , \qquad ( Equation 16 )$$

where the summation ranges from 1 to N.

The accuracy of this force analysis model improves with an increased number of discretized contact points, corresponding to additional wheel units on the platform. The ZMP position calculation ensures the platform maintains stability during operation by analyzing the current supplied to the pistons to estimate reaction forces at each contact point.

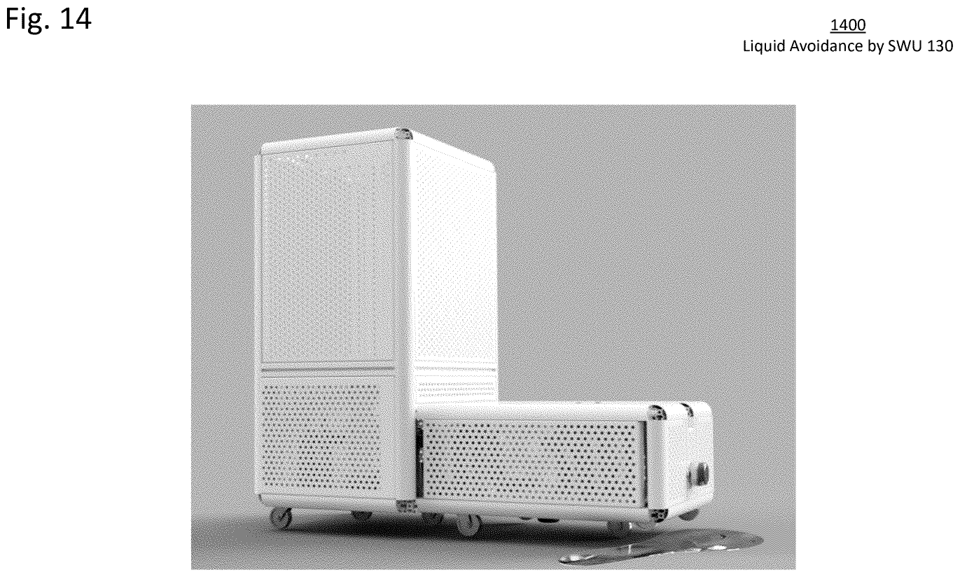

FIG. 14 illustrates liquid avoidance 1400 by a self-lifting wheel unit 130 in accordance with aspects of the disclosure.

The transport system 100 manages various obstacles, including conduits, liquids, and other distributed regions such as gaps, through integrated motion planning and physical topology sensing. When geometric or dynamic constraints prevent successful management, the transport system 100 provides feedback to the user.

Since contact points exist only at the wheels without other forces like magnets or suction cups, the vertical component of the ground reaction forces becomes zero for all points f_{iz}≥0 (i=1, . . . , N). The region of the zero-moment point (ZMP) can be expressed as:

$${\sum }_{i = 1}^{N} {α}_{i} {p}_{i} \vert {p}_{i} ∈ S ( i = 1 , … , N ) \qquad ( Equation 17 )$$

The actuator uses a DC motor that pushes or retracts a plunger, where the force produced is proportional to the armature current (controller input u). Thus, the current flows through the armature winding, creating a magnetic field that interacts with the magnetic field of the permanent magnets or field winding, producing a force on the armature, causing the pushing/retracting. More accurately, f=k/İ, where k is a constant that depends on the motor's construction and the magnetic field strength. Substituting this term in Equation 13 cuts the constant motor k, producing a direct mapping between the current input and ZMP position. Finally, the points pᵢ∈S(i=1, . . . , N) are defined respect the cart base reference frame. Then, the location of the ZMP is obtained by the following equations:

$${p}_{x} = \frac{{\sum }_{i = 1}^{N} {p}_{ix} {\dot{I}}_{i}}{{\sum }_{i = 1}^{N} {\dot{I}}_{i}} , \qquad ( Equations 18 )$$

$${p}_{y} = \frac{{\sum }_{i = 1}^{N} {p}_{iy} {\dot{I}}_{i}}{{\sum }_{i = 1}^{N} {\dot{I}}_{i}}$$

where i ranges from 1 to N. Any differentiator can be used to obtain the derivative of the current input.

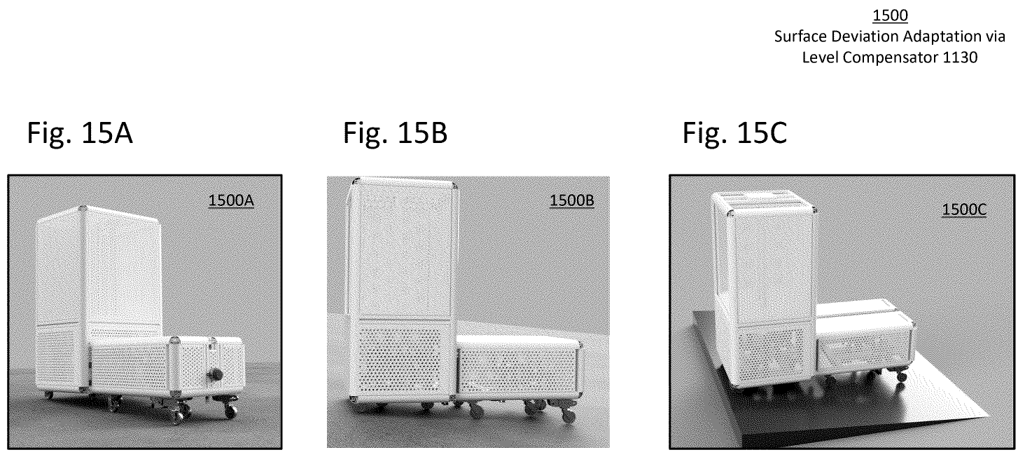

FIGS. 15A-15C illustrates surface deviation adaptation 1500 via a level compensator 1130 of a self-lifting wheel unit 130 in accordance with aspects of the disclosure.

The transport system 100 fuses the four-dimensional spatial perception with the inertial measurement unit (IMU) to control the orientation of the platform to a certain range limited by the maximal deviation between the SWU 130s. This allows management of ramps and variable inclination up to two slopes.

The transport system 100 uses the estimated ZMP along with the orientation data from the IMU sensor to decide the feasibility of control actions with two aims: to prevent the platform from overturning and to keep the platform's orientation as horizontal as possible relative to the gravitational vector. This horizontal alignment ensures that tools and materials stay secure and do not topple over.

The level compensator 1130 calculates the current ZMP by initially deciding the convex hull of the platform. The convex hull is defined by the actuators that satisfy the condition the condition I≥Iₜ, where Iₜ is a threshold for the current input, measured when a wheel contacts the ground.

Consider the set of points S_{I}{(I₁ₓ, I_{1y}), . . . , (Iᵢₓ, I_{iy})} with respect to a coordinate frame Oₚ and compute the largest convex polygon that encompasses the points within this set. The transport system 100 introduces the following smooth function designed to ensure the current ZMP location remains within the boundaries of the stable convex hull:

$$ρ = {e}^{- {γ}_{ZMP} \vert {ZMP}_{m} - Z M {P}_{e} \vert} \qquad ( Equation 19 )$$

where, ZMPₘ is the estimated ZMP, ZMPₑ is the ZMP at the geometric center of the convex hull, and γ_{ZMP} is a hyperparameter. When ρ approaches zero, indicating platform instability, the control action is deactivated by:

$${u}_{cmp} = {u}_{e} ρ . \qquad ( Equation 20 )$$

Additionally, a notification is issued to the user through the display interface 120, indicating that the platform has not identified a viable path to navigate around the conduits. The alert tells the user that they may need to move the conduit or alter the platform's trajectory manually.

The level compensator 1130's concluding function is to preserve the platform's orientation parallel to the ground, preventing tools or equipment from being dislodged and falling. Using roll (ϕ) and pitch (θ) measurements from the IMU, refined by a Mahony filter to align with the gravitational vector, the system establishes a desired distance for each wheel:

$${1}_{i} = T {+}^{P} {R}_{B} {b}_{i} - {b}_{i} , \qquad ( Equation 21 )$$

where T is the current transformation between the ground and the platform origin Oₚ, R is the rotation error matrix R=R_{y}(−θ)Rₓ(−ϕ), and bᵢ is the distance from Oₚ to the wheel actuator. This introduces the final part of the signal controller:

$$u = {u}_{cmp} + α ( {1}_{i} - ψ ) , \qquad ( Equation 22 )$$

where α(⋅) is a controller function.

The transport system 100 provides integration capabilities for both human-operated carts and autonomous mobile robots (AMRs) to enable obstacle traversal functionality.

For human-propelled carts, the transport system 100 implements a user interface 120 that communicates obstacle detection and required actions through multiple modalities: visual displays showing detected obstacles and required maneuvers, audio signals indicating obstacle presence, LED indicators signaling traversal status, and/or top-view representations overlaying wheel positions and obstacle locations. The interface informs operators whether: (a) traversal is possible, (b) velocity adjustment is needed, or (c) steering maneuvers are required.

For AMR integration, the transport system 100 communicates speed and heading requirements through ROS (Robot Operating System) messages or other middleware platforms to coordinate with the robot's navigation stack. An arbitration system prioritizes velocity commands based on obstacle traversal requirements, allowing dynamic path adjustments when navigating over detected obstacles.

The integration approach enables the obstacle detection and traversal capabilities to be implemented across different platforms while maintaining appropriate control interfaces for both human operators and autonomous systems. The transport system 100 adapts its output and control signals based on the specific platform requirements and operator type.

The aspects of the disclosure provide a solution to the challenges associated with floor obstacle navigation, adaptive control, and safe transportation of heavy and fragile items, particularly in industrial settings.

The disclosed aspects revolutionize transportation by enabling smooth traversal over conduits such as hoses, wires, and pipes. Unlike traditional systems that rely on stop-and-go interruptions or ramps, the aspects ensure efficient and bump-less trajectories. This capability significantly enhances the transportation of heavy and fragile loads, creating a safer and more efficient paradigm shift in the movement of tools and supplies within fabrication facilities. By eliminating disruptions, the system improves operational flow and reduces wear and tear on transported items.

The adaptive wheel-lifting mechanism ensures stability during traversal by keeping at least three to four wheels in contact with the ground. The system leverages sensor data from an Inertial Measurement Unit (IMU) and motor-force feedback to compute the center of mass and support polygon dynamically. This advanced mechanism guarantees dependable support and stability, even when navigating uneven surfaces or obstacles.

The disclosed aspects also facilitate seamless deployment through an automatic self-registration process for sensors and wheels. This feature ensures dependable control by maintaining coherent platform specifications in a Robot Operating System (ROS)-Universal Robot Description Format (URDF) model. The self-calibration process simplifies maintenance and allows for straightforward retrofitting of existing carts. By eliminating the need for human intervention, this feature reduces downtime and ensures consistent performance.

The disclosed transport system is particularly advantageous for cost-intensive, rapid-response operations such as foundries, hospitals, and other environments. Its capability to safely transport heavy, fragile, and dangerous items, such as crystal tool-parts, liquids, or thin silicon wafers, makes it invaluable for environments requiring precise and stable handling. The transport system is also well-suited for collaborative human-robot operations, further enhancing productivity and safety in facilities like bio-labs, nuclear facilities, and semiconductor fabrication plants.

There is increased productivity, safety, and retrofitting potential. By seamlessly navigating obstacles without delays, the transport system ensures rapid maintenance, reduces downtimes, and reduces operational bottlenecks. This efficiency enhancement is particularly beneficial for high-cost Fabs, translating into significant cost savings globally. Also, the transport system ensures the integrity of transported items and enhances employee safety by planning and executing soft motions. It also identifies infeasible situations to avoid accidents and damages, making it a reliable choice for high-stakes environments. Further, the modular nature of the transport system allows it to be retrofitted to existing platforms (carts) and expanded to Automated Mobile Robots (AMRs). Integration with ROS nodes ensures compatibility and scalability for future advancements.

In summary, the disclosed transport system addresses challenges in obstacle navigation, stability, and ease of deployment while offering significant productivity, safety, and retrofitting benefits for industrial and operations.

The techniques of this disclosure may also be described in the following examples.

Example 1. A transport system, comprising: a plurality of self-lifting wheel units individually controllable and mounted to a transport platform; one or more sensors mounted to the transport platform and configured to detect a floor obstacle, floor elevation change, or floor surface irregularity; a control system operatively connected to the plurality of self-lifting wheel units and the one or more sensors, wherein the control system is configured to: receive floor obstacle, elevation change, or surface irregularity detection data from the one or more sensors; plan and control the plurality of self-lifting wheel units to selectively lift or lower to maintain stability of the transport platform when traversing the floor obstacle, the floor elevation change, or the floor surface irregularity; and regulate movement of the transport platform to traverse the floor obstacle, the floor elevation change, or the floor surface irregularity based the plan and control.

Example 2. The transport system of example 1, wherein the control system is further configured to perform transport platform leveler compensation by: maintaining transport platform orientation based on inertial measurements and wheel contact forces of wheels of the plurality of self-lifting wheel units; and adjusting individual heights of the plurality of self-lifting wheel units to maintain orientation of the transport platform level.

Example 3. The transport system of any one or more of examples 1-2 wherein the control system is further configured to determine relative positions of the plurality of self-lifting wheel units and the one or more sensors through an auto-calibration sequence based on only the plurality of self-lifting wheel units.

Example 4. The transport system of any one or more of examples 1-3, wherein: the plurality of self-lifting wheel units includes an actuator brake, and the control system is further configured to regulate the movement of the transport platform through brake control based on a floor obstacle, floor elevation change, or floor surface irregularity traversal requirement, an operational constraint of any of the plurality of self-lifting wheel units, or a stability parameter of the transport platform.

Example 5. The transport system of any one or more of examples 1-4, wherein the control system is further configured to: determine a stability of the transport platform based on self-lifting wheel unit contact forces; and maintain stability within predefined parameters during a lifting sequence of the plurality of self-lifting wheel units.

Example 6. The transport system of any one or more of examples 1-5, wherein the control system is further configured to maintain stability and orientation of the transport platform by: determining a zero-moment point (ZMP) based on wheel contact forces of wheels of the plurality of self-lifting wheel units; and maintaining the ZMP within stability boundaries during a wheel lifting or lowering operation.

Example 7. The transport system of any one or more of examples 1-6, wherein the control system is further configured to implement a segmentoid-based floor obstacle, floor elevation change, or floor surface irregularity characterization model that combines Gaussian and sigmoid kernels to model floor obstacle, floor elevation change, or floor surface irregularity geometry.

Example 8. The transport system of example 7, wherein the segmentoid-based floor obstacle, floor elevation change, or floor surface irregularity characterization model: processes the obstacle detection data to generate a representation of the floor obstacle the floor elevation change, or the floor surface irregularity based on adaptive line segments.

Example 9. The transport system of any one or more of examples 1-8, further comprising: a user interface configured to provide information regarding the floor obstacle, the floor elevation change, or the floor surface irregularity, and regarding transport platform movement information.

Example 10. The transport system of any one or more of examples 1-9, wherein the control system is further configured to: generate or receive a spatial representation of an environment of the transport platform; and use the spatial representation to plan a lift sequence for the plurality of self-lifting wheel units.

Example 11. The transport system of any one or more of examples 1-10, wherein the control system is further configured to: determine timing requirements for movements of the plurality of self-lifting wheel units based on a velocity of the transport platform; and proportionally regulate the movement of the transport platform when the velocity exceeds an actuation timing capability of the plurality of self-lifting wheel units, such that the transport platform requires slower traversal for floor obstacle avoidance, the floor elevation change, or the floor surface irregularity.

Example 12. A component of a transport system, comprising: processor circuitry; and a non-transitory computer-readable storage medium including instructions that, when executed by the processor circuitry, cause the processor circuitry to: receive floor obstacle, floor elevation change, or floor surface irregularity detection data from one or more sensors mounted to a transport platform; plan and control a plurality of self-lifting wheel units individually controllable and mounted to the transport platform, to selectively lift or lower while maintaining stability of the transport platform during traversal of a detected floor obstacle, a floor elevation change, or a floor surface irregularity; and regulating movement of the transport platform to traverse the detected floor obstacle, the floor elevation change, or the floor surface irregularity.

Example 13. The component of example 12, wherein the instructions further cause the processor circuitry to: maintain transport platform orientation based on inertial measurements and wheel contact forces of wheels of the plurality of self-lifting wheel units; and adjust individual heights of the plurality of self-lifting wheel units to maintain orientation of the transport platform.

Example 14. The component of any one or more of examples 12-13, wherein the instructions further cause the processor circuitry to: determine relative positions of the plurality of self-lifting wheel units and the one or more sensors through an auto-calibration sequence based on only the self-lifting wheel units.

Example 15. The component of any one or more of examples 12-14, wherein: the plurality of self-lifting wheel units includes an actuator brake, and the instructions further cause the processor circuitry to regulate the movement of the transport platform through brake control based on a floor obstacle, floor elevation change, or floor surface irregularity traversal requirement, an operational constraint of any of the plurality of self-lifting wheel units, or a stability parameter of the transport platform.

Example 16. The component of any one or more of examples 12-15, wherein the instructions further cause the processor circuitry to: determine a stability of the transport platform based on self-lifting wheel unit contact forces; and maintain stability within predefined parameters during a lifting sequence of the plurality of self-lifting wheel units.

Example 17. The component of any one or more of examples 12-16, wherein the instructions further cause the processor circuitry to maintain stability and orientation of the transport platform by: determining a zero-moment point (ZMP) based on wheel contact forces of wheels of the plurality of self-lifting wheel units; and maintaining the ZMP within stability boundaries during a wheel lifting or lowering operation.

Example 18. The component of any one or more of examples 12-17, wherein the instructions further cause the processor circuitry to implement a segmentoid-based floor obstacle, floor elevation change, or floor surface irregularity characterization model that combines Gaussian and sigmoid kernels to model floor obstacle, floor elevation change, or floor surface irregularity geometry.

Example 19. The component of example 18, wherein the segmentoid-based floor obstacle, floor elevation change, or floor surface irregularity characterization model: processes obstacle detection data to generate a representation of the floor obstacle, the floor elevation change, or the floor surface irregularity based on adaptive line segments.

Example 20. The component of any one or more of examples 12-19, wherein the instructions further cause the processor circuitry to: provide, via a user interface, information regarding the floor obstacle, the floor elevation change, or the floor surface irregularity, and regarding transport platform movement information.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A transport system, comprising:
a plurality of self-lifting wheel units individually controllable and mounted to a transport platform;
one or more sensors mounted to the transport platform and configured to detect a floor obstacle, floor elevation change, or floor surface irregularity;
a control system operatively connected to the plurality of self-lifting wheel units and the one or more sensors, wherein the control system is configured to:
receive floor obstacle, elevation change, or surface irregularity detection data from the one or more sensors;
plan and control the plurality of self-lifting wheel units to selectively lift or lower to maintain stability of the transport platform when traversing the floor obstacle, the floor elevation change, or the floor surface irregularity; and
regulate movement of the transport platform to traverse the floor obstacle, the floor elevation change, or the floor surface irregularity based the plan and control.

2. The transport system of claim 1, wherein the control system is further configured to perform transport platform leveler compensation by:
maintaining transport platform orientation based on inertial measurements and wheel contact forces of wheels of the plurality of self-lifting wheel units; and
adjusting individual heights of the plurality of self-lifting wheel units to maintain orientation of the transport platform.

3. The transport system of claim 1, wherein the control system is further configured to determine relative positions of the plurality of self-lifting wheel units and the one or more sensors through an auto-calibration sequence based on only the plurality of self-lifting wheel units.

4. The transport system of claim 1, wherein:
the plurality of self-lifting wheel units includes an actuator brake, and
the control system is further configured to regulate the movement of the transport platform through brake control based on a floor obstacle, floor elevation change, or floor surface irregularity traversal requirement, an operational constraint of any of the plurality of self-lifting wheel units, or a stability parameter of the transport platform.

5. The transport system of claim 1, wherein the control system is further configured to:
determine a stability of the transport platform based on self-lifting wheel unit contact forces; and
maintain stability within predefined parameters during a lifting sequence of the plurality of self-lifting wheel units.

6. The transport system of claim 1, wherein the control system is further configured to maintain stability and orientation of the transport platform by:
determining a zero-moment point (ZMP) based on wheel contact forces of wheels of the plurality of self-lifting wheel units; and
maintaining the ZMP within stability boundaries during a wheel lifting or lowering operation.

7. The transport system of claim 1, wherein the control system is further configured to implement a segmentoid-based floor obstacle, floor elevation change, or floor surface irregularity characterization model that combines Gaussian and sigmoid kernels to model floor obstacle, floor elevation change, or floor surface irregularity geometry.

8. The transport system of claim 7, wherein the segmentoid-based floor obstacle, floor elevation change, or floor surface irregularity characterization model:
processes obstacle detection data to generate a representation of the floor obstacle the floor elevation change, or the floor surface irregularity based on adaptive line segments.

9. The transport system of claim 1, further comprising:
a user interface configured to provide information regarding the floor obstacle, the floor elevation change, or the floor surface irregularity, and regarding transport platform movement information.

10. The transport system of claim 1, wherein the control system is further configured to:
generate or receive a spatial representation of an environment of the transport platform; and
use the spatial representation to plan a lift sequence for the plurality of self-lifting wheel units.

11. The transport system of claim 1, wherein the control system is further configured to:
determine timing requirements for movements of the plurality of self-lifting wheel units based on a velocity of the transport platform; and
proportionally regulate the movement of the transport platform when the velocity exceeds an actuation timing capability of the plurality of self-lifting wheel units, such that the transport platform requires slower traversal for floor obstacle avoidance, the floor elevation change, or the floor surface irregularity.

12. A component of a transport system, comprising:
processor circuitry; and
a non-transitory computer-readable storage medium including instructions that, when executed by the processor circuitry, cause the processor circuitry to:
receive floor obstacle, floor elevation change, or floor surface irregularity detection data from one or more sensors mounted to a transport platform;
plan and control the plurality of self-lifting wheel units to selectively lift or lower to maintain stability of the transport platform when traversing the floor obstacle, the floor elevation change, or the floor surface irregularity; and
regulate movement of the transport platform to traverse the floor obstacle, the floor elevation change, or the floor surface irregularity based the plan and control.

13. The component of claim 12, wherein the instructions further cause the processor circuitry to:
maintain transport platform orientation based on inertial measurements and wheel contact forces of wheels of the plurality of self-lifting wheel units; and
adjust individual heights of the plurality of self-lifting wheel units to maintain orientation of the transport platform.

14. The component of claim 12, wherein the instructions further cause the processor circuitry to:
determine relative positions of the plurality of self-lifting wheel units and the one or more sensors through an auto-calibration sequence based on only the plurality of self-lifting wheel units.

15. The component of claim 12, wherein:
the plurality of self-lifting wheel units includes an actuator brake, and
the instructions further cause the processor circuitry to regulate the movement of the transport platform through brake control based on a floor obstacle, floor elevation change, or floor surface irregularity traversal requirement, an operational constraint of any of the plurality of self-lifting wheel units, or a stability parameter of the transport platform.

16. The component of claim 12, wherein the instructions further cause the processor circuitry to:
determine a stability of the transport platform based on self-lifting wheel unit contact forces; and
maintain stability within predefined parameters during a lifting sequence of the plurality of self-lifting wheel units.

17. The component of claim 12, wherein the instructions further cause the processor circuitry to maintain stability and orientation of the transport platform by:
determining a zero-moment point (ZMP) based on wheel contact forces of wheels of the plurality of self-lifting wheel units; and
maintaining the ZMP within stability boundaries during a wheel lifting or lowering operation.

18. The component of claim 12, wherein the instructions further cause the processor circuitry to implement a segmentoid-based floor obstacle, floor elevation change, or floor surface irregularity characterization model that combines Gaussian and sigmoid kernels to model floor obstacle, floor elevation change, or floor surface irregularity geometry.

19. The component of claim 18, wherein the segmentoid-based floor obstacle, floor elevation change, or floor surface irregularity characterization model:
processes obstacle detection data to generate a representation of the floor obstacle, the floor elevation change, or the floor surface irregularity based on adaptive line segments.

20. The component of claim 12, wherein the instructions further cause the processor circuitry to:
provide, via a user interface, information regarding the floor obstacle, the floor elevation change, or the floor surface irregularity, and regarding transport platform movement information.
